(19) United States
(12) Patent Application Publication
(10) Pub. No.: US 2016/0359209 A1
(43) Pub. Date: Dec. 8, 2016

(54) THERMALLY CONDUCTIVE POLYMER SEPARATOR

(71) Applicant: ROBERT BOSCH GMBH, Stuttgart (DE)

(72) Inventors: Dirk Schmiederer, Lerma (MX); Maximilian Oscar Bader, Muenchen (DE)

(73) Assignee: Robert Bosch GMBH, Stuttgart (DE)

(21) Appl. No.: 15/104,417

(22) PCT Filed: Dec. 1, 2014
(86) PCT No.: PCT/EP2014/076065

§ 371 Date: Aug. 30, 2016

(30) Foreign Application Priority Data
Dec. 19, 2013 (DE) 10 2013 226 743.6

(51) Int. Cl. H01M 10/653; H01M 10/0525; H01M 10/0587; H01M 2/16

(52) U.S. Cl. CPC H01M 10/653; H01M 2/166; H01M 10/0525; H01M 10/0587

(57) ABSTRACT

A lithium cell coil for a lithium cell, which includes an anode a cathode, and a separator situated between the anode and the cathode. To enable a use of lithium cells, for example, lithium-ion cells, in high-performance applications, the separator includes one or multiple layers, the layer or the layers of the separator being heat conducting and the separator including at least one porous polymer layer, which contains at least one heat conducting, electrically insulating, inorganic additive. In addition, the invention relates to a separator, an electrical insulation layer, and a manufacturing method therefor, and also a lithium cell equipped therewith.

### FIELD OF THE INVENTION

The present invention relates to a lithium cell coil for a lithium cell, a lithium cell, and a separator, an electrical insulation layer, and a manufacturing method therefor.

### BACKGROUND INFORMATION

Lithium-ion rechargeable batteries generally have a metal housing, in which one or multiple cell coils, so-called jelly rolls, are installed to form a battery cell. A cell coil is formed by multiple rolled layers located one on top of another. The layer structure includes a layer made of anode material, a layer made of separator material, and a layer made of cathode material.

Heat may arise in the cell interior on the anode and cathode materials during charging or during operation of the cell. In addition, the temperature of the cell may be influenced by low ambient temperatures.

Controlling the temperature of lithium-ion rechargeable batteries, for example, heating and/or cooling, via the outer wall of the base of the metal housing to ensure an optimum operating temperature in the cell is known.

The patent document DE 10 2011 010 243 A1 discusses a porous polymer foil or diaphragm having a thin coating made of an electrically nonconductive, ceramic composition, which may be used as a separator in a lithium-ion battery.

The patent document DE 199 14 272 A1 discusses a separator having a shutdown function.

### SUMMARY OF THE INVENTION

An object of the present invention is a lithium cell coil for a lithium cell, for example, a so-called jelly roll, which includes an anode, a cathode, and a separator situated between the anode and the cathode. For example, the lithium cell coil may be a lithium-ion cell coil for a lithium-ion cell, for example, for a lithium-ion rechargeable battery.

The separator may include one or multiple layers. The layer or the layers, for example, all layers of the separator may be heat conducting in particular. In particular, the separator may include at least one porous polymer layer, which contains at least one heat conducting, electrically insulating, inorganic additive.

An additive may be understood in particular as a material which may be added—for example, in the form of a powder—to a polymer. The additive may be added to the polymer in particular in a quantity of ≧1 wt. %, for example, ≧10 wt. %, for example, ≧30 wt. %, in relation to the total weight, in particular of the polymer layer.

In particular a material which has a higher specific heat conductivity than the matrix material of the polymer layer, in particular than the polymer or the polymers of the polymer layer, may be understood as heat conducting. For example, a material having a specific heat conductivity of greater than 1 Wm⁻¹K⁻¹, in particular greater than 10 Wm⁻¹K⁻¹, for example, greater than 20 Wm⁻¹K⁻¹, for example, greater than 50 Wm⁻¹K⁻¹ may be understood as heat conducting.

For example, a material having a specific electrical resistance of greater than 10⁶ Ω·m, in particular greater than 10⁸ Ω·m, may be understood as electrically insulating.

Because the heat conducting, electrically insulating, inorganic additive is added to the polymer layer of the separator, the properties of the polymer layer may be modified and the polymer layer may advantageously be equipped with increased thermal conductivity—while maintaining an electrical insulation capability. This in turn advantageously enables heat to be transported through the separator. In particular, the thermal conductivity may thus be advantageously increased perpendicularly in relation to the layers, for example, the anode, the separator, and the cathode, and/or the layering of the cell coil. This in turn advantageously enables heat which arises, for example, during operation of the cell coil or the cell, in the interior, for example, on the anode and/or cathode material, to be dissipated laterally outward, in particular toward the side walls of a cell housing which accommodates the cell coil, or heat to be supplied therefrom, and thus to temperature-control the cell coil and/or the cell via the side walls of the cell housing.

This is generally not possible in the case of conventional cell coils and cells, since the typical separator materials are mostly heat insulating, and this is in combination with the layer structure of the cell coil, which, as a result of the rolling up of the layering of a plurality of heat insulating separator layers between heat conducting anode and cathode layers, obstructs a heat flow perpendicularly in relation to the cell coil layers toward the cell housing side walls, the heat conducting anode and cathode layers promoting a heat flow along the anode and cathode layers toward the cell housing base, which is why the temperature control only takes place via the cell housing base in this case.

However, a cell coil according to the present invention may advantageously be temperature-controlled via the side walls of the cell housing. The area provided by the cell housing side walls is—depending on the particular design—generally multiple times larger than the area of the cell housing base, which enables improved temperature control to be achieved via the cell housing side walls. In addition, in the cell coil according to the present invention, conventional temperature control via the cell housing base is also possible. In particular, the overall thermal resistance of the cell coil and the cell may advantageously be reduced and the temperature control may thus be improved.

Overall—as a result of the increased heat conductivity—it is thus advantageously made possible to transport heat more rapidly into the cell interior toward the thermally critical and relevant components or to dissipate heat therefrom, respectively, and in this way to implement effective temperature control of the cell coil and the cell, for example, the lithium-ion cell, via side walls (and optionally additionally via the base). This in turn advantageously enables a use of lithium cells, for example, lithium-ion cells, for example, lithium-ion rechargeable batteries, in high-performance applications, for example, in which particularly effective and high-performance temperature control is required.

By adding a heat conducting, electrically insulating, inorganic additive, the separator may advantageously be provided in a particularly simple way with increased heat conductivity and, for example, may be manufactured simply and cost-effectively, for example, using known manufacturing methods. The remaining properties of the polymer layer, which result from the requirement spectrum for the separator, may advantageously be maintained and, for example, the performance of the cell coil may be ensured by the use of an additive.

It may be basically sufficient if at least one layer of the separator is electrically insulating. However, it is also possible that the layer or the layers, in particular all layers of the separator are electrically insulating—and in particular heat conducting and electrically insulating.

In addition to the at least one porous polymer layer, the separator may also include one or multiple further layer(s). This/these further layer(s) may also be porous in particular. The porous layers of the separator may in particular have a porosity which ensures permeability to lithium ions. Insofar as the further layer(s) is/are lithium-ion-conducting, however, it/they may also be configured as dense or nonporous.

Within the scope of one specific embodiment, the cell coil additionally has an electrical insulation layer. In particular, the insulation layer may be electrically insulating. The insulation layer may be configured, for example, for electrically insulating layers of the cell coil, for example, different turns of the cell coil, from one another. For example, the insulation layer may electrically insulate an anode or an anode current collector from a cathode or a cathode current collector. In particular, the insulation layer may include a dense or nonporous layer.

Within the scope of one special embodiment, the insulation layer is additionally heat conducting. This advantageously also enables heat to be transported through the insulation layer and the thermal conductivity to be increased perpendicularly in relation to the layers, for example, the anode, the separator, and the cathode, and the layering of the cell coil, and thus to further improve a temperature control of the cell coil and the cell via the side walls of the cell housing and, for example, the high-performance capability.

For example, the insulation layer may include one or multiple layers, the layer or the layers, for example, all layers of the insulation layer being heat conducting. It may be basically sufficient if at least one layer is electrically insulating. However, it is also possible that the layer or the layers, in particular all layers of the insulation layer are electrically insulating—and in particular heat conducting and electrically insulating.

In particular, the insulation layer may include at least one polymer layer, which contains at least one heat conducting, electrically insulating, inorganic additive. By adding a heat conducting, electrically insulating, inorganic additive, the insulation layer, in particular while maintaining an electrical insulation capability, may be provided in a particularly simple way with increased heat conductivity and, for example, may be manufactured simply and cost-effectively, for example, using known manufacturing methods.

For example, the at least one additive, in particular of the at least one polymer layer of the separator and/or the insulation layer, may be a particulate additive. The at least one polymer layer of the separator and the at least one polymer layer of the insulation layer may include both identical or different additives and also identical or different polymers.

Within the scope of another specific embodiment, the at least one additive, in particular of the at least one polymer layer of the separator and/or the insulation layer, includes spherical and/or flaky particles or is formed therefrom. Spherical and/or flaky particles may be admixed well to polymers. In addition, a homogeneous particle distribution and therefore also a homogeneous heat distribution may advantageously be achieved in this way. In particular, the at least one additive, in particular of the at least one polymer layer of the separator and/or the insulation layer, may include spherical particles or be formed therefrom. Particularly good mixing and homogeneous heat distribution may advantageously be achieved in this way.

The at least one additive, in particular of the at least one polymer layer of the separator and/or the insulation layer may be selected, for example, from the group of nitrides, oxides, and carbonates, in particular nitrides and/or oxides, for example, of boron, aluminum, silicon, magnesium, calcium, and titanium, in particular boron and/or magnesium and/or aluminum and/or silicon, and mixtures thereof. These material classes may advantageously have suitable specific heat conductivities and specific electrical resistances.

For example, the at least one additive, in particular of the at least one polymer layer of the separator and/or the insulation layer, may be selected from the group including boron nitride (BN), magnesium oxide (MgO), aluminosilicate(s), aluminum oxide (Al₂O₃), aluminum nitride (AlN), silicon nitride (Si₃N₄), silicon oxide(s), for example, cristobalite, wollastonite, and/or talcum, titanium oxide (TiO₂), chalk, and mixtures thereof. Boron nitride, magnesium oxide, aluminosilicates, aluminum oxide, aluminum nitride, silicon nitride, silicon oxides, for example, cristobalite, wollastonite, and/or talcum, titanium oxide, and chalk advantageously have—in comparison to the matrix material of the at least one polymer layer—increased specific thermal conductivity with electrical insulation at the same time. Boron nitride, aluminum nitride, magnesium oxide, aluminum oxide, and aluminosilicates advantageously have comparatively high specific heat conductivities. Magnesium oxide, aluminum oxide, titanium oxide, and/or silicon oxide, for example, cristobalite, wollastonite, and/or talcum, and aluminosilicates, may advantageously be used as particularly cost-effective materials.

Within the scope of another specific embodiment, the at least one additive, in particular of the at least one polymer layer of the separator and/or the insulation layer, is selected from the group including boron nitride, magnesium oxide, aluminosilicate, aluminum oxide, aluminum nitride, and mixtures thereof.

In particular, the at least one additive, in particular of the at least one polymer layer of the separator and/or the insulation layer, may include or be boron nitride and/or magnesium oxide and/or aluminosilicate and/or aluminum oxide and/or aluminum nitride. For example, boron nitride and/or magnesium oxide and/or aluminosilicate and/or aluminum oxide and/or aluminum nitride and/or cristobalite may be used as a single additive or in any arbitrary mixture or combination. Boron nitride may be used because of its comparatively very high heat conductivity.

Within the scope of one special embodiment, the at least one additive, in particular of the at least one polymer layer of the separator and/or the insulation layer, therefore includes or is boron nitride, for example, a hexagonal boron nitride. Boron nitride advantageously has a comparatively very high specific heat conductivity.

Alternatively or additionally, the at least one additive, in particular of the at least one polymer layer of the separator and/or the insulation layer, may also include or be aluminum oxide, however. Aluminum oxide is advantageously cost-effective and has an acceptable specific thermal conductivity.

Alternatively or additionally, the at least one additive, in particular of the at least one polymer layer of the separator and/or the insulation layer, may include or be aluminosilicate and/or magnesium oxide. Aluminosilicate and magnesium oxide are advantageously cost-effective and have an acceptable or good specific heat conductivity.

Within the scope of another specific embodiment, the at least one polymer layer, in particular of the separator and/or the insulation layer, in relation to the total weight of the at least one polymer layer, in particular of the separator and/or the insulation layer, contains ≧1 wt. %, for example, ≧10 wt. %, for example, ≧30 wt. % of the at least one additive.

One or multiple polymers, for example, polyolefins, such as polyethylene (PE), polypropylene (PP), polytetrafluoroethylene (PTFE), polyvinyl chloride (PVC), or a mixture or combination thereof, may advantageously be used for the at least one polymer layer, in particular of the separator and/or the insulation layer.

Within the scope of another specific embodiment, the at least one polymer layer, in particular of the separator and/or the insulation layer, includes at least one polymer of the group of polyolefins, which are in particular non-halogenated and/or halogenated, and mixtures thereof. Polyolefins have proven to be particularly suitable, for example. The at least one polymer layer may optionally be formed from the at least one polymer. Formed may be understood in particular to mean that the at least one polymer layer may also contain, in addition to the at least one polymer, additives, such as the at least one heat conducting, electrically insulating, inorganic additive. For example, the at least one polymer layer, in particular of the separator and/or the insulation layer, may include at least one polymer or be formed therefrom, which is selected from the group of polyolefins, in particular polyethylene (PE) and/or polypropylene (PP), halogenated polyolefins, in particular polytetrafluoroethylene (PTFE) and/or polyvinyl chloride (PVC), and mixtures thereof. In particular, the at least one polymer layer, in particular of the separator and/or the insulation layer, may include at least one polymer or be formed therefrom, which is selected from the group of non-halogenated polyolefins, for example, polyethylene (PE) and/or polypropylene (PP), in particular polyethylene (PE), and mixtures thereof. Non-halogenated polyolefins, in particular polyethylene, may advantageously be comparatively cost-effective and environmentally compatible and may have a slightly better heat conductivity than halogenated polyolefins.

The separator and/or the insulation layer may be a multilayer composite, each independently of one another.

Within the scope of another specific embodiment, the separator and/or the insulator layer is therefore a multilayer composite. In the multilayer composite, in particular both one layer and multiple or even all layers may be polymer layers containing at least one heat conducting, electrically insulating, inorganic additive. Different polymer layers may have both identical and different heat conducting, electrically insulating, inorganic additives and/or both identical and different polymers.

Within the scope of another specific embodiment, the separator and/or the insulation layer therefore additionally has at least one further porous polymer layer, which includes at least one other polymer and/or at least one other heat conducting, electrically insulating, inorganic additive.

The separator and/or the insulation layer may optionally additionally also include one or multiple further layers, which are formed from another material, for example, a ceramic material.

Within the scope of another alternative or additional specific embodiment, the separator and/or the insulation layer therefore additionally include(s) at least one heat conducting, lithium-ion-conducting, and/or porous ceramic layer. For example, the ceramic layer may be electrically insulating. Insofar as the ceramic layer is lithium-ion-conducting, the layer may also be dense or nonporous.

Furthermore, the cell coil may include an anode current collector and/or a cathode current collector. The anode current collector and/or the cathode current collector may be configured, for example, in the form of a metal foil. For example, the anode may be applied in the form of an anode layer to the anode current collector. The cathode may be applied, for example, in the form of a cathode layer to the cathode current collector. The anode current collector may be formed from copper, for example. The cathode current collector may be formed from aluminum, for example.

The anode may include, for example, a lithium intercalation material, for example, graphite, and/or metallic lithium. For example, the anode may be configured in the form of an anode layer containing a lithium intercalation material and/or in the form of a lithium-containing metal foil, for example, lithium foil.

The cathode may include, for example, a, in particular different lithium intercalation material, for example, lithium manganese oxide and/or lithium cobalt oxide and/or lithium nickel oxide. For example, the cathode may be configured in the form of a cathode layer containing lithium intercalation material.

The electrical insulation layer may be configured, for example, in the form of a coating on the anode current collector and/or the cathode current collector, in particular on the side of the anode current collector facing away from the anode or on the side of the cathode current collector facing away from the cathode.

The electrical insulation layer may also be configured in the form of a foil, for example, a diaphragm, however. For example, the insulation foil may be able to be situated or may be situated between the anode current collector (or the anode) of one turn of the cell coil and the cathode current collector (or the cathode) of an adjacent turn of the cell coil.

The separator may be configured, for example, in the form of a foil, for example, a diaphragm, or a coating.

For example, the cell coil may be manufactured by a method according to the present invention.

Reference is hereby explicitly made to the explanations in conjunction with the separator according to the present invention, the electrical insulation layer according to the present invention, the cell according to the present invention, and the method according to the present invention and to the figures and the description of the figures with respect to further technical features and advantages of the cell coil according to the present invention.

Further objects of the present invention are a separator for a lithium cell coil or a lithium cell and/or an electrical insulation layer for a lithium cell coil or a lithium cell. In particular, the separator or the insulation layer may be configured for a lithium cell coil according to the present invention or a lithium cell according to the present invention and/or may be manufactured by a method according to the present invention.

The separator may include in particular one or multiple layers, the layer or the layers, for example, all layers of the separator being able to be heat conducting. In particular, the separator may include at least one porous polymer layer, which contains at least one heat conducting, electrically insulating, inorganic additive.

The electrical insulation layer may also include in particular one or multiple layers, the layer or the layers, for example, all layers, of the insulation layer being able to be heat conducting. In particular, the insulation layer may include at least one polymer layer, which contains at least one heat conducting, electrically insulating, inorganic additive.

It may be basically sufficient if at least one layer of the separator is electrically insulating. However, it is also possible that the layer or the layers, for example, all layers of the separator are electrically insulating—and in particular heat conducting and electrically insulating.

In addition to the at least one porous polymer layer, the separator may also include one or multiple further layers. This further layer or these further layers may also be porous in particular. Insofar as the further layer(s) is/are lithium-ion conductive, however, it/they may also be dense or nonporous.

The insulation layer may be electrically insulating in particular. The insulation layer may be configured, for example, for electrically insulating layers of the cell coil, for example, different turns of the cell coil, from one another. For example, the insulation layer may electrically insulate an anode or an anode current collector from a cathode or a cathode current collector. In particular, the insulation layer may include or be a dense or nonporous layer.

In particular, the insulation layer may be heat conducting. A more homogeneous temperature distribution may thus advantageously be achieved, peak temperatures may be reduced, and more rapid and energy-efficient temperature control, for example, heating or cooling, of the cell may be implemented.

For example, the insulation layer may include one or multiple layers, the layer or the layers, for example, all layers of the insulation layer being able to be heat conducting. It may be basically sufficient if at least one layer is electrically insulating. However, it is also possible that the layer or the layers, for example, all layers, of the insulation layer are electrically insulating—and in particular heat conducting and electrically insulating.

In particular, the insulation layer may include at least one polymer layer, which contains at least one heat conducting, electrically insulating, inorganic additive.

For example, the at least one additive, in particular of the at least one polymer layer of the separator and/or the insulation layer, may be a particulate additive. The at least one polymer layer of the separator and the at least one polymer layer of the insulation layer may include both identical or different additives and identical or different polymers.

Within the scope of one embodiment, the at least one additive, in particular of the at least one polymer layer of the separator and/or the insulation layer, includes spherical and/or flaky particles, for example, spherical particles, or is formed therefrom.

The at least one additive, in particular of the at least one polymer layer of the separator and/or the insulation layer, may be selected, for example, from the group of nitrides, oxides, and carbonates, in particular nitrides and/or oxides, for example, of boron, aluminum, silicon, magnesium, calcium, and titanium, in particular boron and/or magnesium and/or aluminum and/or silicon, and mixtures thereof. For example, the at least one additive, in particular of the at least one polymer layer of the separator and/or the insulation layer, may be selected from the group including boron nitride, magnesium oxide, aluminosilicate(s), aluminum oxide, aluminum nitride, silicon nitride, silicon oxide(s), for example, cristobalite, wollastonite, and/or talcum, titanium oxide, chalk, and mixtures thereof.

Within the scope of another embodiment, the at least one additive, in particular of the at least one polymer layer of the separator and/or the insulation layer, is selected from the group including boron nitride, magnesium oxide, aluminosilicate, aluminum oxide, aluminum nitride, and mixtures thereof. For example, the at least one additive, in particular of the at least one polymer layer of the separator and/or the insulation layer, may include or be boron nitride and/or magnesium oxide and/or aluminosilicate and/or aluminum oxide and/or aluminum nitride, in particular boron nitride.

Within the scope of another embodiment, the at least one polymer layer, in particular of the separator and/or the insulation layer, includes 1 wt. %, for example, 10 wt. %, for example, 30 wt. % of the at least one additive in relation to the total weight of the at least one polymer layer, in particular of the separator and/or the insulation layer.

Within the scope of another embodiment, the at least one polymer layer, in particular of the separator and/or the insulation layer, includes at least one polymer of the group of the polyolefins, in particular non-halogenated or halogenated polyolefins, for example, polyethylene and/or polypropylene and/or polytetrafluoroethylene and/or polyvinyl chloride, in particular polyethylene, and mixtures thereof, or is formed therefrom.

Within the scope of another embodiment, the separator and/or the insulation layer is a multilayer composite. For example, the separator and/or the insulation layer may additionally include at least one further porous polymer layer, which includes at least one other polymer and/or at least one other heat conducting, electrically insulating, inorganic additive. The separator and/or the insulation layer may optionally additionally also include one or multiple further layers which are formed from another material, for example, a ceramic material. For example, the separator and/or the insulation layer may additionally include at least one heat conducting, lithium-ion-conducting, and/or porous ceramic layer. For example, the ceramic layer may be electrically insulating. Insofar as the ceramic layer is lithium-ion-conducting, the layer may also be dense or nonporous.

The separator and/or the insulation layer may be configured, for example, in the form of a foil, for example, a diaphragm, or a coating.

Reference is hereby explicitly made with respect to the explanations in conjunction with the cell coil according to the present invention, the cell according to the present invention, and the method according to the present invention and to the figures and the description of the figures with respect to further technical features and advantages of the separator according to the present invention and the electrical insulation layer according to the present invention.

A further object of the present invention is a lithium cell, for example, a lithium-ion cell, which includes (at least) one cell coil according to the present invention and/or one separator according to the present invention and/or one electrical insulation layer according to the present invention and/or is manufactured by a method according to the present invention.

The cell may in particular include a heat conducting, for example, metallic cell housing. The cell housing may in particular include at least one side wall and, for example, a base. For example, a cylindrical cell housing may have a side wall. A prismatic cell housing may have four side walls, for example.

The (at least one) cell coil may in particular be introducible or introduced into the cell housing. The (at least one) cell coil may be in particular in thermal contact with the cell housing. In particular, a lateral outer surface of the (at least one) cell coil may be in thermal contact with at least one side wall inner surface, optionally with all side wall inner surfaces of the cell housing.

Reference is hereby explicitly made to the explanations in conjunction with the cell coil according to the present invention, the separator according to the present invention, the insulation layer according to the present invention, and the method according to the present invention and to the figures and the description of the figures with respect to further technical features and advantages of the cell according to the present invention.

Furthermore, the present invention relates to a method for manufacturing a separator according to the present invention and/or an electrical insulation layer according to the present invention and/or a cell coil according to the present invention and/or a lithium cell according to the present invention.

The method may include in particular the following method steps:
a) adding or mixing at least one heat conducting, electrically insulating, inorganic additive to at least one polymer or into at least one polymer; and
b) forming a porous or dense polymer layer from the mixture from method step a).

In particular, the at least one additive in method step a) may be mixed in the form of a powder into the at least one polymer.

Furthermore, the method may include, for example, the following method step:
c) forming an anode-separator-cathode arrangement and/or an anode current collector-anode-separator-cathode-cathode current collector arrangement, which is equipped with an electrical insulation layer;
   the separator including at least one porous polymer layer from method step b) and/or the insulation layer including at least one dense polymer layer from method step b).

The anode may include, for example, a lithium intercalation material, for example, graphite, and/or metallic lithium. For example, the anode may be configured in the form of an anode layer containing a lithium intercalation material and/or in the form of a lithium-containing metal foil, for example, lithium foil. For example, the anode may be applied in the form of an anode layer containing a lithium intercalation material to the anode current collector, for example, a copper foil.

The cathode may include, for example, a, in particular different lithium intercalation material, for example, lithium manganese oxide and/or lithium cobalt oxide and/or lithium nickel oxide. For example, the cathode may be configured in the form of a cathode layer containing lithium intercalation material. For example, the cathode may be applied in the form of a cathode layer to the cathode current collector, for example, an aluminum foil.

Furthermore, the method may include, for example, the following method step:
d) coiling the arrangement from method step c) to form a cell coil.

Furthermore, the method may include the following method step, for example:
e) introducing the cell coil, optionally multiple cell coils, from method step d) into a heat conducting, for example, metallic cell housing.

Furthermore, the method may include the following method step or steps:
introducing an electrolyte into the cell housing; and/or
electrically contacting the anode and/or the anode current collector and/or the cathode and/or the cathode current collector; and/or
closing the cell housing, for example, by way of a cover.

Reference is hereby explicitly made to the explanations in conjunction with the cell coil according to the present invention, the separator according to the present invention, the insulation layer according to the present invention, and the cell according to the present invention, and to the figures and the description of the figures with respect to further technical features and advantages of the method according to the present invention.

Further advantages and advantageous embodiments of the objects according to the present invention are illustrated by the drawings and explained in the following description. It is to be noted that the drawings only have descriptive character and are not intended to restrict the present invention in any form.

### BRIEF DESCRIPTION OF THE DRAWINGS

FIG. 1 shows a schematic cross section through one specific embodiment of a separator according to the present invention.

FIG. 2 shows a schematic cross section through another specific embodiment of a separator according to the present invention in the form of a multilayer composite.

FIG. 3 shows a schematic cross-sectional detail of one specific embodiment of a lithium cell coil according to the present invention.

FIG. 4 shows a larger cross-sectional detail of the specific embodiment shown in FIG. 3 of a lithium cell coil according to the present invention.

### DETAILED DESCRIPTION

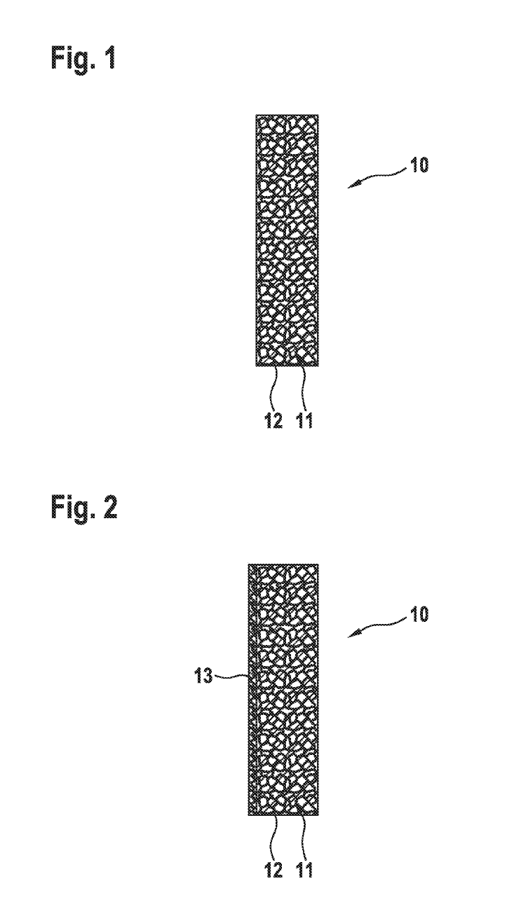

FIG. 1 shows one specific embodiment of a separator 10 according to the present invention, which includes a porous layer 11 made of a heat conducting plastic. FIG. 1 illustrates in particular that separator 10 includes a porous polymer layer 11, which contains a heat conducting, electrically insulating, inorganic additive 12. FIG. 1 indicates that additive 12 may be a particulate additive based on spherical and/or flaky particles. For example, boron nitride and/or magnesium oxide and/or aluminosilicate and/or aluminum oxide may be used individually or in mixtures as additive 12. The polymer of the polymer layer may be, for example, a non-halogenated or halogenated polyolefin, for example, polyethylene, or a mixture thereof.

FIG. 2 shows another specific embodiment of a separator 10 according to the present invention, within the scope of which separator 10 is configured in the form of a multilayer composite 11, 13. FIG. 2 illustrates that separator 10, in addition to porous polymer layer 11 containing heat conducting, electrically insulating, inorganic additive 12, may include a further layer 13. Further layer 13 may be, for example, a further porous polymer layer, which includes a different polymer and/or a different heat conducting, electrically insulating, inorganic additive. FIG. 2 indicates that further layer 13 may also be a heat conducting, lithium-ion-conducting and/or porous ceramic layer.

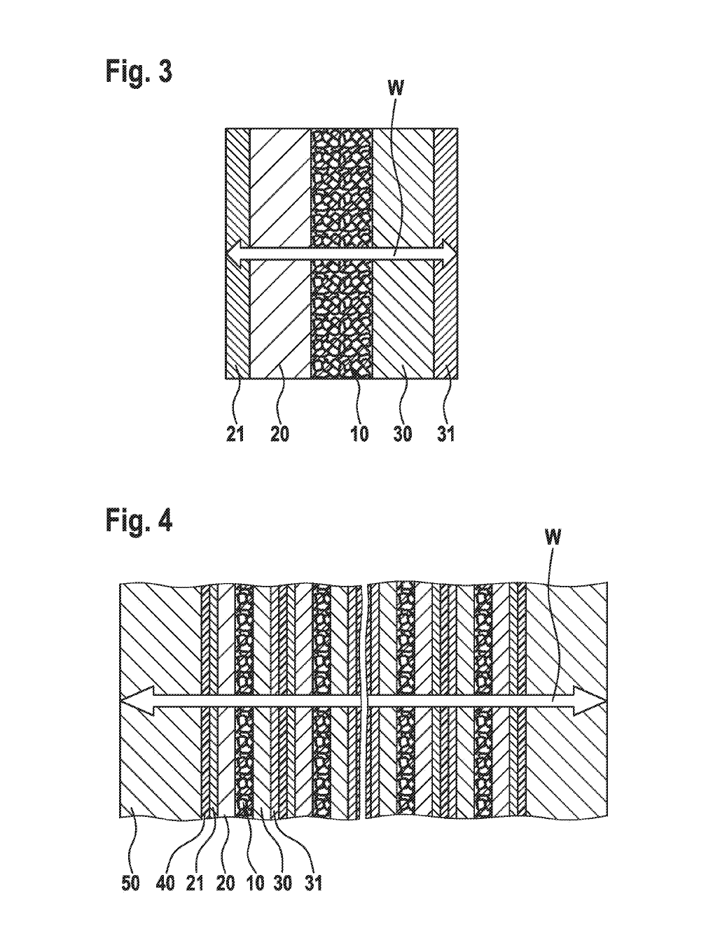

FIG. 3 shows one specific embodiment of a cell coil 21, 20, 10, 30, 31 according to the present invention, which includes an anode 20, a cathode 30, and a separator 10, which is situated between anode 20 and cathode 30. Separator 10 is made heat conducting and includes at least one porous polymer layer, which contains at least one heat conducting, electrically insulating, inorganic additive.

FIG. 3 shows that cell coil 21, 20, 10, 30, 31 furthermore includes an anode current collector 21 and a cathode current collector 31, anode 20 resting against anode current collector 21 and cathode 30 resting against cathode current collector 31.

Arrow W in FIG. 3 illustrates that because separator 10 is heat conducting, heat W may be transported through separator 10 and in particular perpendicularly in relation to layers 21, 20, 10, 30, 31 of cell coil 21, 20, 10, 30, 31.

FIG. 4 shows a larger cross-sectional detail of the specific embodiment of a lithium cell coil 40, 21, 20, 10, 30, 31 according to the present invention as shown in FIG. 3. FIG. 4 shows that cell coil 40, 21, 20, 10, 30, 31 furthermore includes an electrical insulation layer 40, which electrically insulates anode current collector 21 of one turn of cell coil 40, 21, 20, 10, 30, 31 from a cathode current collector 31 of an adjacent turn of cell coil 40, 21, 20, 10, 30, 31. Insulation layer 40 may be configured in particular to be electrically insulating and heat conducting. For example, insulation layer 40 may include at least one, in particular dense polymer layer 13, which contains at least one heat conducting, electrically insulating, inorganic additive. The additive of insulation layer 40 may also be particulate in particular and may include, for example, spherical and/or flaky particles. For example, boron nitride and/or magnesium oxide and/or aluminosilicate and/or aluminum oxide may also be used here, individually or in mixtures, as the additive.

FIG. 4 furthermore shows that cell coil 40, 21, 20, 10, 30, 31 is introduced into a cell housing 50 made of a heat conducting, for example, metallic material. FIG. 4 illustrates that the lateral outer surfaces of cell coil 40, 21, 20, 10, 30, 31 rest against side wall inner surfaces of cell housing 50 and are in thermal contact therewith.

Arrow W in FIG. 4 shows that because separator 10 and insulation layer 40 are configured to be heat conducting, heat W may be transported through separator 10 and insulation layer 40 and in particular perpendicularly in relation to layers 40, 21, 20, 10, 30, 31 of cell coil 40, 21, 20, 10, 30, 31 outward toward the side walls of cell housing 50.

1-15. (canceled)

16. A lithium cell coil for a lithium cell, comprising:
an anode;
a cathode; and
a separator situated between the anode and the cathode;
wherein the separator includes at least one layer, the at least one layer of the separator being heat conducting, and
wherein the separator includes at least one porous polymer layer, which contains at least one heat conducting, electrically insulating, inorganic additive.

17. The lithium cell coil of claim 16, wherein the cell coil includes an electrical insulation layer, the insulation layer including at least one layer, the at least one layer of the insulation layer being heat conducting, the insulation layer including at least one polymer layer which contains at least one heat conducting, electrically insulating, inorganic additive.

18. The lithium cell coil of claim 16, wherein the at least one additive includes at least one of spherical particles and flaky particles, or is formed therefrom.

19. The lithium cell coil of claim 16, wherein the at least one additive is selected from the group including boron nitride, magnesium oxide, aluminosilicate, aluminum oxide, aluminum nitride, and mixtures thereof.

20. The lithium cell coil of claim 16, wherein the at least one polymer layer contains ≧10 wt. % of the at least one additive in relation to the total weight of the at least one polymer layer.

21. The lithium cell coil of claim 16, wherein the at least one polymer layer includes at least one polymer which is selected from the group of non-halogenated and/or halogenated polyolefins and mixtures thereof.

22. The lithium cell coil of claim 16, wherein at least one of the separator and the insulation layer is a multilayer composite.

23. The lithium cell coil of claim 22, wherein at least one of the separator and the insulation layer additionally includes at least one further porous polymer layer, which includes at least one other polymer and/or at least one other heat conducting, electrically insulating, inorganic additive.

24. The lithium cell coil of claim 22, wherein at least one of the separator and the insulation layer additionally includes at least one heat conducting, lithium-ion-conducting, and/or porous ceramic layer.

25. A separator for a lithium cell coil or a lithium cell, comprising:
at least one layer, wherein the at least one layer is of a separator and is heat conducting, the separator including at least one porous polymer layer, which contains at least one heat conducting, electrically insulating, inorganic additive,
wherein the lithium cell coil or the lithium cell includes an anode and a cathode, wherein the separator is situated between the anode and the cathode.

26. The separator of claim 25, wherein the lithium cell coil or the lithium cell includes an electrical insulation layer, the insulation layer including at least one layer, the at least one layer of the insulation layer being heat conducting, the insulation layer including at least one polymer layer which contains at least one heat conducting, electrically insulating, inorganic additive.

27. An electrical insulation layer for a lithium cell coil or a lithium cell, comprising:
at least one layer, wherein the at least one layer is of an insulation layer and is heat conducting, the insulation layer including at least one polymer layer, which contains at least one heat conducting, electrically insulating, inorganic additive;
wherein the lithium cell coil or the lithium cell includes an anode and a cathode, and a separator situated between the anode and the cathode, wherein the separator includes the at least one layer, the at least one layer of the separator being heat conducting.

28. The insulation layer of claim 27, wherein the lithium cell coil or the lithium cell includes an electrical insulation layer, the insulation layer including at least one layer, the at least one layer of the insulation layer being heat conducting, the insulation layer including at least one polymer layer which contains at least one heat conducting, electrically insulating, inorganic additive.

29. A lithium cell, comprising:
at least one of the following:
at least one lithium cell coil, including an anode, a cathode; and a separator situated between the anode and the cathode, wherein the separator includes at least one layer, the at least one layer of the separator being heat conducting, and wherein the separator includes at least one porous polymer layer, which contains at least one heat conducting, electrically insulating, inorganic additive;
a separator including at least one layer, wherein the at least one layer is heat conducting, the separator including at least one porous polymer layer, which contains at least one heat conducting, electrically insulating, inorganic additive, wherein the lithium cell includes an anode and a cathode, wherein the separator is situated between the anode and the cathode; and
an electrical insulation layer cell, including at least one layer, wherein the at least one layer is of an insulation layer and is heat conducting, the insulation layer including at least one polymer layer, which contains at least one heat conducting, electrically insulating, inorganic additive, wherein the lithium cell includes an anode and a cathode, and a separator situated between the anode and the cathode, wherein the separator includes the at least one layer, the at least one layer of the separator being heat conducting; and
a heat conducting and metallic cell housing having at least one side wall, wherein the at least one cell coil is introducible or introduced into the cell housing, a lateral outer surface of the at least one cell coil is in thermal contact with at least one side wall inner surface of the cell housing.

30. A method for manufacturing at least one of a lithium cell coil, a separator, an electrical insulation layer, and a lithium cell, the method comprising:
mixing at least one heat conducting, electrically insulating, inorganic additive, in particular in the form of a powder, into at least one polymer; and
forming a porous or dense polymer layer from the mixture from the mixing task;
wherein the at least one lithium cell coil, includes an anode, a cathode; and a separator situated between the anode and the cathode, wherein the separator includes at least one layer, the at least one layer of the separator being heat conducting, and wherein the separator includes at least one porous polymer layer, which contains at least one heat conducting, electrically insulating, inorganic additive;
wherein the a separator includes at least one layer, wherein the at least one layer is heat conducting, the separator including at least one porous polymer layer, which contains at least one heat conducting, electrically insulating, inorganic additive, wherein the lithium cell includes an anode and a cathode, wherein the separator is situated between the anode and the cathode;
wherein the electrical insulation layer cell, includes at least one layer, wherein the at least one layer is of an insulation layer and is heat conducting, the insulation layer including at least one polymer layer, which contains at least one heat conducting, electrically insulating, inorganic additive, wherein the lithium cell includes an anode and a cathode, and a separator situated between the anode and the cathode, wherein the separator includes the at least one layer, the at least one layer of the separator being heat conducting; and
wherein the lithium cell, includes at least one layer, wherein the at least one layer is of an insulation layer and is heat conducting, the insulation layer including at least one polymer layer, which contains at least one heat conducting, electrically insulating, inorganic additive, wherein the lithium cell includes an anode and a cathode, and a separator situated between the anode and the cathode, wherein the separator includes the at least one layer, the at least one layer of the separator being heat conducting, and includes a heat conducting and metallic cell housing having at least one side wall, wherein the at least one cell coil is introducible or introduced into the cell housing, a lateral outer surface of the at least one cell coil is in thermal contact with at least one side wall inner surface of the cell housing.
